(19) United States
(12) Patent Application Publication
(10) Pub. No.: US 2014/0198738 A1
(43) Pub. Date: Jul. 17, 2014

(54) TECHNIQUES TO MANAGE PAGING CYCLES FOR MACHINE-TO-MACHINE DEVICES

(71) Applicants: Rui Huang, Beijing (CN); Honggang Li, Beijing (CN)

(72) Inventors: Rui Huang, Beijing (CN); Honggang Li, Beijing (CN)

(21) Appl. No.: 13/977,006

(22) PCT Filed: Mar. 27, 2012
(86) PCT No.: PCT/CN2012/073103

§ 371 Date: Jun. 27, 2013

(51) Int. Cl. H04W 52/28; H04W 4/00; H04W 76/02; H04W 68/02

(52) U.S. Cl. CPC H04W 52/281; H04W 68/02; H04W 4/005; H04W 76/02
USPC 370/329

(57) ABSTRACT

Techniques to control paging cycles for machine-to-machine (M2M) devices are described. An apparatus may comprise a processor circuit, a connection manager component arranged for execution by the processor circuit to establish a wireless connection with a device, and a paging component arranged for execution by the processor circuit to select a paging class for the device from among multiple paging classes, each paging class associated with a different paging cycle and paging class parameter, with at least one of the multiple paging classes comprising a M2M paging class associated with a M2M paging cycle and a M2M paging class parameter. Other embodiments are described and claimed.

### BACKGROUND

Machine to Machine (M2M) communications is emerging as a dynamic technology enabling an “Internet of things” to exchange information without human interaction. Recent trends predict an exponential increase in a number of M2M devices in a mobile broadband network, including devices of the type used as parking meters, surveillance cameras, utility meters, and other non-human interface applications.

A basic design goal for M2M systems is extremely low power consumption. Extremely low power consumption implies that the M2M device consumes extremely low operational power over extended periods of time. This M2M feature is particularly important for battery-limited M2M devices, such as those M2M devices that have little or no access to power sources, infrequent human interaction, or high cost of charging due to a lot of sensors. However, many wireless networks are focused on reducing power consumption based solely on human interface communication. It is with respect to these and other considerations that the present improvements have been needed.

### BRIEF DESCRIPTION OF THE DRAWINGS

FIG. 1 illustrates an embodiment of an apparatus.

FIG. 2 illustrates an embodiment of a first logic flow.

FIG. 3 illustrates an embodiment of a second logic flow.

FIG. 4 illustrates an embodiment of a third logic flow.

FIG. 5 illustrates an embodiment of a fourth logic flow.

FIG. 6 illustrates an embodiment of a packet for the apparatus.

FIG. 7 illustrates an embodiment of a storage medium.

FIG. 8 illustrates an embodiment of a device.

FIG. 9 illustrates an embodiment of a communications system.

### DETAILED DESCRIPTION

Embodiments are generally directed to improvements for wireless networks. More particularly, embodiments are directed to improvements for paging and power management of M2M devices in wireless networks. A M2M device is any device that is capable of providing M2M communication. M2M communication is an information exchange between user devices through a network access device, such as a base station, or between a device and a server in the core network through a base station that may be carried out without any human interaction.

Wireless mobile broadband technologies may include any wireless technologies suitable for use with M2M devices, such as one or more third generation (3G) or fourth generation (4G) wireless standards, revisions, progeny and variants. Examples of wireless mobile broadband technologies may include without limitation any of the Institute of Electrical and Electronics Engineers (IEEE) 802.16m and 802.16p standards, 3rd Generation Partnership Project (3GPP) Long Term Evolution (LTE) and LTE-Advanced (LTE ADV) standards, and International Mobile Telecommunications Advanced (IMT-ADV) standards, including their revisions, progeny and variants. Other suitable examples may include without limitation Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1xRTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8 and 9 of LTE/System Architecture Evolution (SAE), and so forth. The embodiments are not limited in this context.

By way of example and not limitation, various embodiments may be described with specific reference to various 3GPP LTE and LTE ADV standards, such as the 3GPP LTE Evolved UMTS Terrestrial Radio Access Network (E-UTRAN), Universal Terrestrial Radio Access (E-UTRA) and LTE ADV Radio Technology 36 Series of Technical Specifications (collectively “3GPP LTE Specifications”), and IEEE 802.16 standards, such as the IEEE 802.16-2009 standard and current third revision to IEEE 802.16 referred to as “802.16Rev3” consolidating standards 802.16-2009, 802.16h-2010 and 802.16m-2011, and the IEEE 802.16p draft standards including IEEE P802.16.1b/D2 Jan. 2012 titled “Draft Amendment to IEEE Standard for WirelessMAN-Advanced Air Interface for Broadband Wireless Access Systems, Enhancements to Support Machine-to-Machine Applications” (“IEEE 802.16p”), or other IEEE 802.16 standards (collectively “IEEE 802.16 Standards”), and any drafts, revisions or variants of the 3GPP LTE Specifications and the IEEE 802.16 Standards. Although some embodiments may be described as a 3GPP LTE Specifications or IEEE 802.16 Standards system by way of example and not limitation, it may be appreciated that other types of communications system may be implemented as various other types of mobile broadband communications systems and standards. The embodiments are not limited in this context.

In wireless networks, idle mode (or sleep mode) is designed to reduce power consumption by wireless devices in the network. While in idle mode, a wireless device may alternate between an availability interval (AI) and an unavailability interval (UAI). During an unavailability interval a wireless device may power down its radio interface, which significantly reduces power consumption for the device. On the other hand, during an availability interval (sometimes referred to as a paging listening interval or DRX), a wireless device needs to apply power to its radio interface in order to communicate with a wireless network to send and/or receive data or management traffic. Thus, a wireless device may send and/or receive traffic during an availability interval while in idle mode.

Current broadband wireless access systems, such as an IEEE 802.16 or 3GPP LTE system, utilize a paging cycle typically optimized for human interface communication. In human interface communication, such as voice communication, an important design consideration is traffic latency. For example, real-time traffic such as voice traffic may need lower latency to meet certain quality of service (QoS) requirements. Therefore, a paging cycle with a longer availability interval may be needed to ensure timely arrival of the voice traffic. However, increasing a length of an availability interval, and conversely decreasing a length of an unavailability interval, means that a wireless device needs to provide power to its radio interface for longer periods of time. This results in higher average power consumption.

M2M devices are not typically designed for human interface communications, and therefore are not as sensitive to traffic latency as non-M2M devices. Rather, a more pressing design consideration for M2M devices is extremely low power consumption. Extremely low power consumption may be achieved by extending a length of an unavailability interval for a paging cycle, as it allows a M2M device to power down its radio interface for longer periods of time.

Therefore, a wireless network utilizing a paging cycle optimized for voice traffic alone is not suitable for M2M devices, and vice-versa. As such, it is difficult to provide a single paging cycle to accommodate needs for both types of wireless devices.

Embodiments attempt to solve these and other problems by assigning different wireless devices to different paging classes, with each paging class having a different paging cycle or portion of a paging cycle. In particular, M2M devices may be assigned to a M2M paging class having a paging cycle (or portion of a paging cycle) optimized for reduced power consumption, while non-M2M devices may be assigned to a non-M2M paging class having a paging cycle (or portion of a paging cycle) optimized for reduced traffic latency. Embodiments may define and utilize a new paging class parameter to indicate a particular paging class for a given type of wireless device. In this manner, a broadband wireless access network may efficiently service different types of devices.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

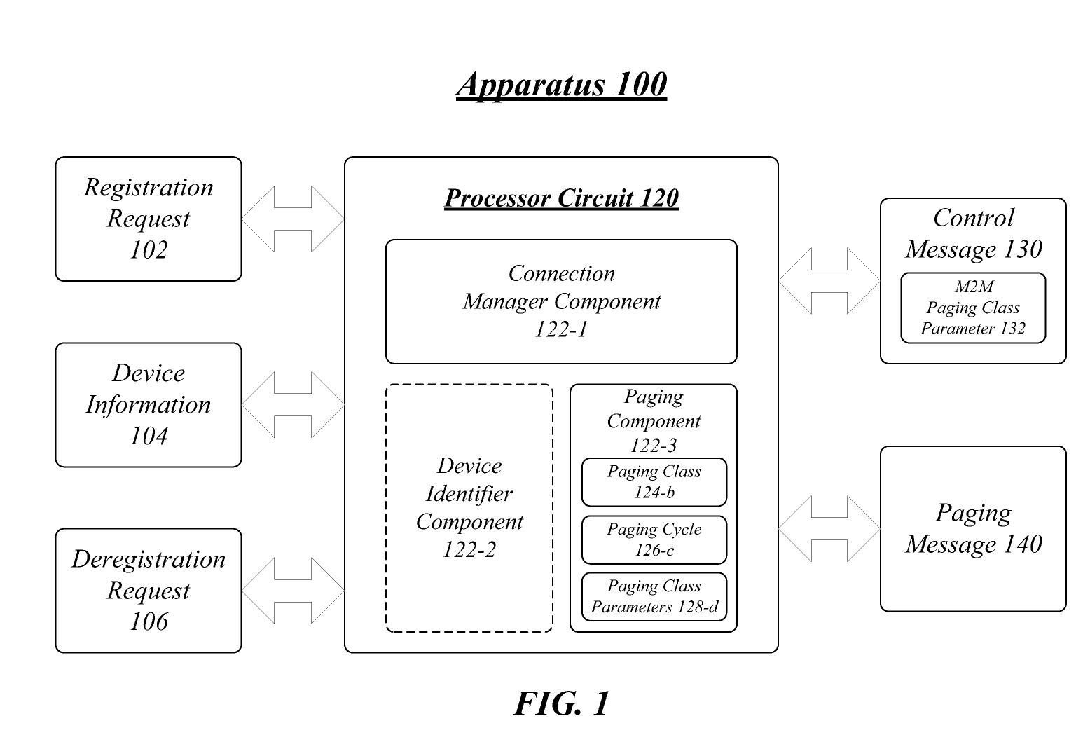

FIG. 1 illustrates a block diagram for an apparatus 100. Although the apparatus 100 shown in FIG. 1 has a limited number of elements in a certain topology, it may be appreciated that the apparatus 100 may include more or less elements in alternate topologies as desired for a given implementation.

The apparatus 100 may comprise a computer-implemented apparatus 100 having a processor circuit 120 arranged to execute one or more software components 122-a. It is worthy to note that “a” and “b” and “c” and similar designators as used herein are intended to be variables representing any positive integer. Thus, for example, if an implementation sets a value for a=5, then a complete set of software components 122-a may include components 122-1, 122-2, 122-3, 122-4 and 122-5. The embodiments are not limited in this context.

In various embodiments, the apparatus 100 may be implemented in any electronic device having access to wireless capabilities or equipment. For example, the apparatus 100 may be implemented in system equipment, user equipment, or a core network for a wireless system.

In one embodiment, the apparatus 100 may be implemented in system equipment for a communications system or network compliant with one or more 3GPP LTE Specifications or IEEE 802.16 Standards. For example, the apparatus 100 may be implemented as part of a base station or eNodeB for a Wireless Metropolitan Area Network (WMAN) or LTE network, or other network devices. Although some embodiments are described with reference to a base station or eNodeB, embodiments may utilize any network equipment for a communications system or network. The embodiments are not limited in this context.

In one embodiment, the apparatus 100 may be implemented in user equipment (UE) for a communications system or network, such as a communications device compliant with one or more 3GPP LTE Specifications or IEEE 802.16 Standards. For example, the apparatus 100 may be implemented as part of a M2M device compliant with one or more IEEE 802.16 Standards. Although some embodiments are described with reference to a M2M device, embodiments may utilize any user equipment for a communications system or network. The embodiments are not limited in this context.

The apparatus 100 may comprise the processor circuit 120. The processor circuit 120 may be generally arranged to execute one or more software components 122-a. The processing circuit 120 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core i3, Core i5, Core i7, Itanium®, Pentium®, Xeon®, and XScale® processors; and similar processors. Dual microprocessors, multi-core processors, and other multi-processor architectures may also be employed as the processing unit 120.

The apparatus 100 may comprise a connection manager component 122-1. The connection manager component 122-1 may be generally arranged to manage wireless connections for the apparatus 100. This includes set-up and tear-down of the wireless connection. For example, the connection manager component 122-1 may establish a wireless connection between a device and a network access point, such as base station or eNodeB. The connection manager component 122-1 may also receive a registration request 102 from a device to register a device with the wireless network using the wireless connection. The connection manager component 122-1 may further receive a deregistration request 106 to deregister the device from the wireless network using the wireless connection. For example, once registered with a network, the device may deregister to enter idle mode while retaining capabilities to periodically receive control traffic and data traffic from the network.

The apparatus 100 may comprise a device identifier component 122-2. In one embodiment, the device identifier component 122-2 may be arranged for execution by the processor circuit 120 to generally determine whether a device is a M2M device or a non-M2M device. This may be accomplished a number of different ways, including explicit and implicit identification techniques. Once a device is identified as a M2M device, the device identifier component 122-2 may output a M2M indicator to the paging component 122-3.

By way of example, to the extent a device is configured with a device type, it may explicitly notify a network whether it is a M2M device or a non-M2M device in an information exchange. Similarly, a network may maintain or retrieve a list of known M2M devices and device identifiers, and the network may identify a device is a M2M device based on its device identifier. The list may include, for example, M2M devices and associated device identifiers as previously determined by the device identifier component 122-2 in a previous communication session with the M2M devices.

If no explicit information is available, the device or the network may implicitly determine a device type based on a variety of factors. One technique may include determining whether a device is a fixed device or a mobile device. A fixed device is a wireless device whose location does not change with time. Since a large portion of M2M devices are fixed devices, indicia of a fixed device may be used to classify a device as a M2M device. However, it can be appreciated that a M2M device may comprise a mobile device as well, and therefore determination that a device is a fixed device alone may be insufficient for all purposes. In such cases, additional confirmation indicia of M2M features may be sought.

There are a number of mechanisms that can be used to identify fixed, as opposed to mobile, devices. One technique to identify fixed devices is through device location information. If the device location does not change with time, this indicates that the device is a fixed device. The device location can be derived from global positioning systems, indoor positioning, Global Navigation Satellite Systems (GNSS), and cellular triangulation, to mention a few examples. If the device location is checked a number of times and is still the same over sufficiently long time periods, the device can be identified as one that is a fixed device. A broadband wireless access network or a M2M server can obtain position information from the device in order to decide if it is a fixed device. Another way to identify M2M devices is based on device function. If a device function is one that indicates that it is a fixed device, this notification can be provided to the global broadband network or M2M server. For example, a device that is a parking meter is known to be a fixed device. Conversely, a cellular telephone would be a function that would indicate that the device is not fixed. As another example, if the device has an onboard accelerometer, the output from the accelerometer can be identified to determine that the device is being used as a fixed device. Still another example is using the received signal strength or received power levels. If the received signal strength or received power level does not change by more than a threshold over a given time period, the device can be classified as being fixed. Other activities that can be monitored to determine whether a device moves include determining activities, such as manual inputs and periodic versus non-periodic activities, to mention a few examples. Still another possibility is that a M2M device knows that it is a fixed device and so notifies the network.

Another technique for implicit M2M identification may include M2M feature comparisons. A M2M feature is a unique characteristic of an M2M application. One or more M2M features may be needed to support an M2M application. A network or device may maintain a list of M2M features, and compare M2M features of a device with the list of M2M features. If there are a defined number of matches (e.g., 1 or more), the device may be classified as a M2M device. Other M2M identification techniques may be used as well, and the embodiments are not limited in this context.

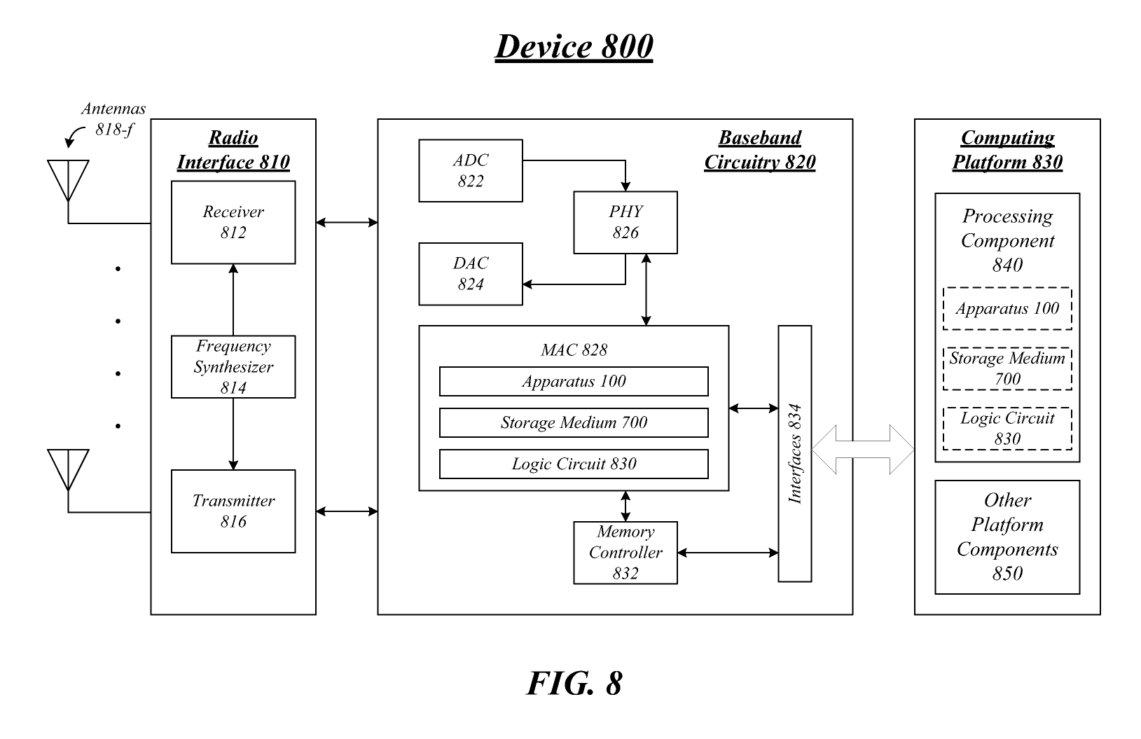

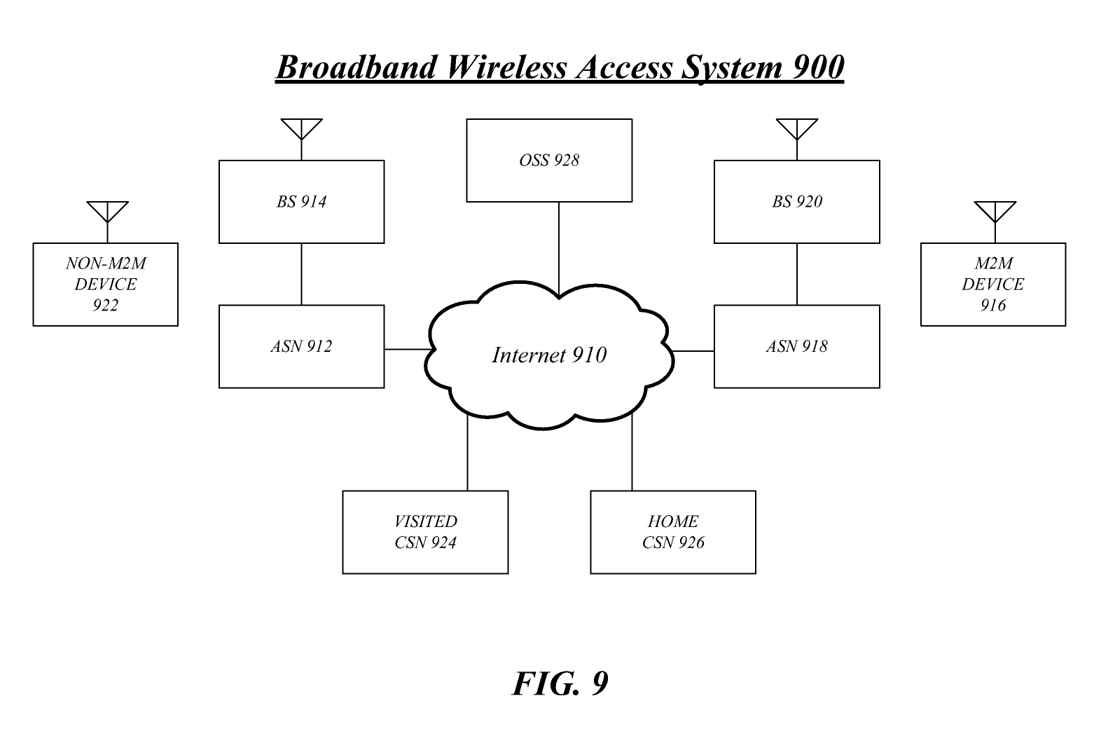

The apparatus 100 may comprise a paging component 122-3. In one embodiment, the paging component 122-3 may be arranged for execution by the processor circuit 120 to generally manage paging operations for a communications device or a communication system, examples of which are described with reference to FIGS. 8, 9, respectively. Every mobile broadband system has some kind of broadcast mechanism to distribute information to multiple devices. Paging is a broadcast service used to set up channels between a communication device and an access device for a radio access network.

In various embodiments, paging operations may be differentiated based on whether a communications device is a M2M device or a non-M2M device. In this manner, paging operations may be customized for different types of devices, thereby resulting in more efficient use of device and system resources. One such efficiency is allowing a M2M device to remain in a lower power mode for an extended period of time. For example, after a certain period of inactivity by a M2M device, the M2M device transitions into a lower power state to conserve battery power and de-allocate radio resources. This is sometimes referred to as an idle mode. During idle mode, the M2M device wakes up periodically for short intervals known as page listening intervals (e.g., availability intervals) to listen for paging messages, and then becomes unavailable again in a pre-negotiated cycle. The longer the M2M device can remain in idle mode, the more power savings the M2M device can realize.

In one embodiment, the paging component 122-3 may receive a M2M indication as to whether a device is a M2M device or a non-M2M device from the device identifier component 122-2. Alternatively, the paging component 122-3 may perform this determination.

The paging component 122-3 may select a paging class for the device from among multiple paging classes 124-b based on the M2M indication received from the device identifier component 122-2. Each paging class 124-b may be associated with a corresponding paging cycle 126-c and paging class parameter 128-d.

A paging class 124-b may comprise a grouping, class or category for devices of a similar type. In one embodiment, at least one of the multiple paging classes 124-b may be reserved for non-M2M devices, and at least one of the multiple paging classes 124-b may be reserved for M2M devices. For example, a network may reserve a paging class 124-1 for non-M2M devices, and a paging class 124-2 for M2M devices. It may be appreciated that more paging classes 124-b may be defined as needed for a given network, including multiple M2M paging classes. The embodiments are not limited in this context.

A paging class 124-b reserved for M2M devices, such as the paging class 124-2 in the previous example, may be referred to herein as a “M2M paging class.” Similarly, a corresponding paging cycle 126-c and paging cycle parameter 128-d for a M2M paging class may be referred to herein as a “M2M paging cycle” and “M2M paging class parameter,” respectively. For example, the M2M paging class 124-2 may have a corresponding M2M paging cycle 126-2 and paging cycle parameter 128-2.

Each paging class 124-b may have an associated paging cycle 126-c suitable for a type of device within that paging class 124-b. In one embodiment, a paging cycle 126-c for one paging class 124-b may have a different length relative to a paging cycle 126-c for another paging class 124-b. Continuing with the previous example, the paging cycle 126-1 for the paging class 124-1 may have a first defined time interval, while the M2M paging cycle 126-2 for the M2M paging class 124-2 may have a second defined time interval different from the first defined time interval. In one embodiment, the first time interval may be shorter than the second time interval. In one embodiment, the first time interval may be longer than the second time interval. Alternatively, some paging classes 124-b may have paging cycles 126-c of a same time interval as desired for a given implementation.

Alternatively, each paging class 124-b may have a portion of an associated paging cycle 126-c suitable for a type of device within that paging class 124-b. In one embodiment, a first portion of a paging cycle 126-c for one paging class 124-b may have a different length relative to a second portion of the paging cycle 126-c for another paging class 124-b. Continuing with the previous example, a first portion of the paging cycle 126-1 for the paging class 124-1 may have a first defined time interval, while a second portion of the same paging cycle 126-1 for the M2M paging class 124-2 may have a second defined time interval different from the first defined time interval. In one embodiment, the first time interval may be shorter than the second time interval. In one embodiment, the first time interval may be longer than the second time interval. Alternatively, some paging classes 124-b may have portions of a paging cycle 126-c of a same time interval as desired for a given implementation.

Assume a non-M2M device, such as a subscriber station or mobile station having voice capabilities, is assigned to paging class 124-1. Further assume a M2M device, such as a parking meter or utility meter, is assigned to paging class 124-2. The paging cycle 126-1 associated with the paging class 124-1 may be set for a shorter time interval than the M2M paging cycle 126-2 associated with the M2M paging class 124-2. For instance, the paging cycle 126-1 may have an unavailability interval measured in milliseconds or seconds, while the M2M paging cycle 126-2 may have an unavailability interval measured in minutes, days, weeks, months or even longer time intervals, and vice-versa for availability intervals. The longer unavailability intervals (or shorter availability intervals) for the M2M paging class 124-2 may allow a M2M device assigned to the M2M paging class 124-2 to enter and remain in a low power mode, such as idle mode or sleep mode, for longer periods of time.

Each paging cycle 126-c may be defined of any desired length suitable for a given implementation. Any time granularity may be defined, such as days, week, months, years, or some other time period. One or more 3GPP LTE Specifications and IEEE 802.16 Standards may need to be modified from a time scale of milliseconds to longer time scales in order to accommodate different time units used by a diversity of fixed M2M devices.

Each paging class 124-b may also have an associated paging class parameter 128-d. A paging class parameter 128-d uniquely identifies a paging class 124-b, and in turn, a paging cycle 126-c associated with the paging class 124-b. In one embodiment, a paging class parameter 128-d may comprise a value, such as one or more bits stored in a memory unit (e.g., a register) or communicated in a message field for a message, that is associated with a defined paging class 124-b.

Once the device identifier component 122-2 identifies a device as an M2M device, and the paging component 122-3 selects a M2M paging class 124-2 for the M2M device, the paging component 122-3 may assign the M2M device to the M2M paging class 124-2. The paging component 122-3 may then send a M2M paging class parameter 132 to the M2M device over a wireless channel via a wireless transceiver. In keeping with the previous example, a M2M paging class parameter 132 may comprise the M2M paging class parameter 128-2 associated with the M2M paging class 124-2 and the M2M paging cycle 126-2. The M2M device may then use the M2M paging class parameter 132 to identify the paging cycle 126-2, and align device operations in accordance with the paging cycle 126-2, such as powering an RF interface during availability intervals and depowering the RF interface during unavailability intervals in an alternating fashion.

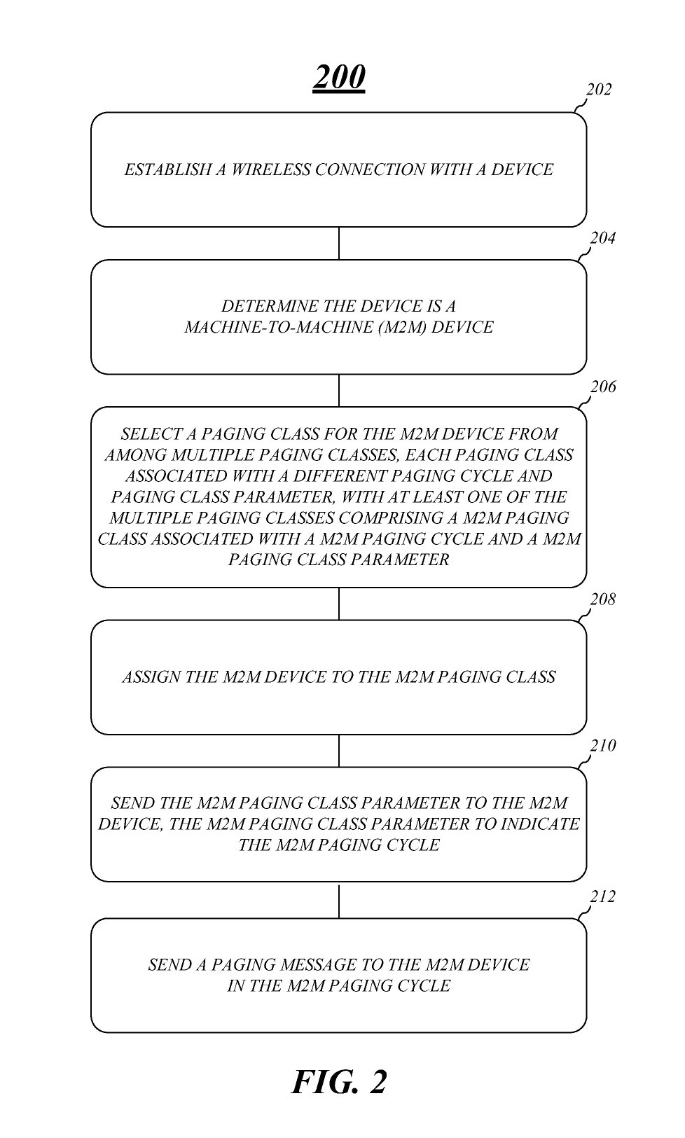

Some exemplary operations and use scenarios for the connection manager component 122-1, the device identifier component 122-2, and/or the paging component 122-3 when executed by the processor circuit 120 may be described with reference to FIGS. 2-5. However, the embodiments are not limited to these examples.

Included herein is a set of logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on a non-transitory computer readable medium or machine readable medium, such as an optical, magnetic or semiconductor storage. The embodiments are not limited in this context.

FIG. 2 illustrates an embodiment of a logic flow 200. The logic flow 200 may be representative of some or all of the operations executed by one or more embodiments described herein, such as the apparatus 100. More particularly, the logic flow 200 may be performed by the apparatus 100 as implemented by system equipment, such as a base station or eNodeB for a radio access network.

In the illustrated embodiment shown in FIG. 2, the logic flow 200 may establish a wireless connection with a device at block 202. For instance, the connection manager component 122-1 may establish a wireless connection with a device over an RF interface for a WMAN or LTE system. The connection manager component 122-1 may establish the wireless connection with a device when the device enters a cell of a wireless network, such as when the device is a mobile device. Similarly, the connection manager component 122-1 may establish a wireless connection with a device when the device powers on, such as when the device is a fixed device positioned within a cell of a wireless network. The connection manager component 122-1 may then perform any registration operations needed for the device, such as authenticating the device, registering the device with the network, assigning a network identifier to the device, allocating radio resources for the device, and other registration procedures. The connection manager component 122-2 may also perform deregistration operations for the device, such as releasing the wireless connection to allow the device to enter an idle mode in the absence of any control or data traffic for the device.

The logic flow 200 may determine the device is a machine-to-machine (M2M) device at block 204. Referring again to FIG. 1, the device identification component 122-2 may receive device information 104 for the device over the wireless connection. The device information 104 may comprise any descriptive information associated with the device that is helpful in determining whether the device is a M2M device (e.g., a parking meter) or a non-M2M device (e.g., a cellular telephone). Examples of device information 104 may include without limitation device capabilities information, device locations, device locations over time, device functions, device identifiers, device names, device components, device sensor information (e.g., an accelerometer, altimeter, environmental, temperature, haptic, etc.), device telemetry, device received signal strength (RSS) or RSS indicator (RSSI), device power levels, device manual inputs, device user profiles, device control information, device data, and so forth. The embodiments are not limited in this context.

The device identifier component 122-2 may determine whether the device is a M2M device based on the device information 104 using any number of techniques as previously described. The device identifier component 122-2 may output an indication that the device is a M2M device to the paging component 122-3.

The logic flow 200 may select a paging class for the M2M device from among multiple paging classes, each paging class associated with a different paging cycle and paging class parameter, with at least one of the multiple paging classes comprising a M2M paging class associated with a M2M paging cycle and a M2M paging class parameter at block 206. For instance, the paging component 122-3 may select a M2M paging class 124-2 when the device is identified as a M2M device. Prior to final selection, there may be a negotiation phase between devices, such as the M2M device and the base station or eNodeB, to determine precisely what paging class 124-b should be selected. For instance, the M2M device may send device information 104 to a base station or eNodeB, including preferences for paging operations, and vice-versa.

The logic flow 200 may assign the M2M device to the M2M paging class at block 208. For instance, the paging component 122-3 may assign the M2M device to the M2M paging class 124-2 selected at block 206.

The logic flow 200 may send the M2M paging class parameter to the M2M device, the M2M paging class parameter to indicate the M2M paging cycle at block 210. For instance, the paging component 122-3 may send the M2M paging class parameter 128-2 associated with the M2M paging class 124-2 as the M2M paging class parameter 132 to the M2M device. The M2M paging class parameter 132 may indicate the M2M paging cycle 126-2 is the paging cycle to be used by the M2M device.

The logic flow 200 may send a paging message to the M2M device in the M2M paging cycle at block 212. Once the paging component 122-3 sends the M2M paging class parameter 132 to the M2M device, the paging component 122-3 may perform paging operations for the M2M device in accordance with the M2M paging cycle 126-2. This may include sending a paging message 140 to the M2M device during an availability interval of the M2M paging cycle 126-2 when there is control or data traffic for the M2M device.

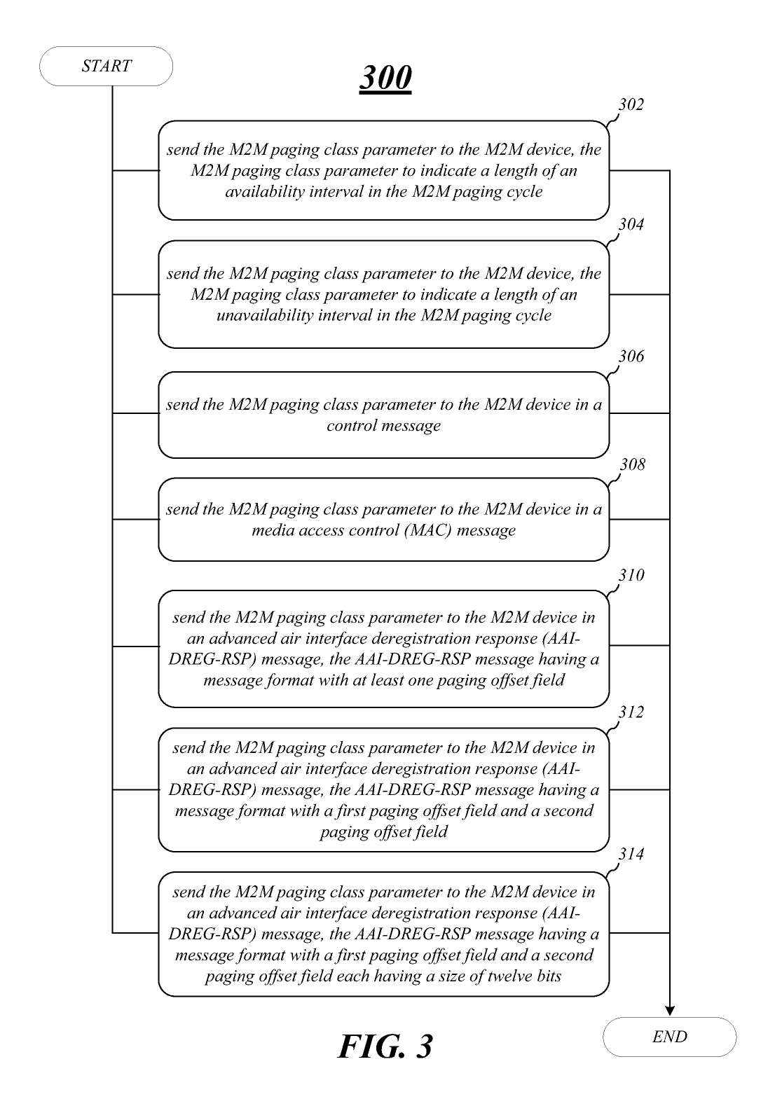

FIG. 3 illustrates an embodiment of a logic flow 300. The logic flow 300 may be representative of some or all of the operations executed by one or more embodiments described herein, such as the paging component 122-3 of the apparatus 100, for example. More particularly, the logic flow 300 may be implemented by the paging component 122-3 to send a control message 130 with the M2M class parameter 132 to one or more M2M devices. The control message 130 may be sent in a downlink (DL) control channel from the apparatus 100, or a device implementing the apparatus 100 (e.g., a base station or eNodeB), to the one or more M2M devices. The DL control channel may be a dedicated control channel or a broadcast control channel. The embodiments are not limited in this context.

In the illustrated embodiment shown in FIG. 3, the logic flow 300 may send the M2M paging class parameter to the M2M device, the M2M paging class parameter to indicate a length of an availability interval in the M2M paging cycle at block 302. For instance, the M2M device may maintain a table of paging class parameters 128-d, corresponding paging cycles 126-c, and lengths associated with an availability interval and/or unavailability interval for the paging cycles 126-c in a look-up table (LUT). In this case, the M2M paging class parameter 132 may comprise a value representing a M2M paging class 124-2, which can be used as an index to LUT to find a length for an availability interval for the M2M paging cycle 126-2. Alternatively, the M2M paging class parameter 132 may be a value that actually represents a length of an availability interval for a known unavailability interval and/or M2M paging cycle 126-2.

The logic flow 300 may send the M2M paging class parameter to the M2M device, the M2M paging class parameter to indicate a length of an unavailability interval in the M2M paging cycle at block 304. As with the availability interval as previously described with reference to block 302, the M2M device may maintain a table of paging class parameters 128-d, corresponding paging cycles 126-c, and lengths associated with an availability interval and/or unavailability interval for the paging cycles 126-c in a look-up table (LUT). In this case, the M2M paging class parameter 132 may comprise a value representing a M2M paging class 124-2, which can be used as an index to LUT to find a length for an unavailability interval for the M2M paging cycle 126-2. Alternatively, the M2M paging class parameter 132 may be a value that actually represents a length of an unavailability interval for a known availability interval and/or M2M paging cycle 126-2.

The logic flow 300 may send the M2M paging class parameter to the M2M device in a control message at block 306. Referring again to FIG. 1, the paging component 122-3 may send a control message 130 with the M2M paging class parameter 132 to the M2M device. The control message 130 may be a control message as defined by any known communications protocols, standards or specifications, such as one or more of the IEEE 802.16 Standards or 3GPP LTE Specifications. For instance, the control message 130 may comprise a control message for IEEE 802.16p, among others. The control message may be, for example, broadcasted to multiple user equipment on a control channel accessible by the multiple user equipment.

The logic flow 300 may send the M2M paging class parameter to the M2M device in a media access control (MAC) message at block 308. More particularly, the control message 130 may comprise a MAC control message as defined by any known communications protocols, standards or specifications, such as one or more of the IEEE 802.16 Standards or 3GPP LTE Specifications. For instance, the control message 130 may comprise a MAC control message for IEEE 802.16p, among others.

The logic flow 300 may send the M2M paging class parameter to the M2M device in an advanced air interface deregistration response (AAI-DREG-RSP) message, the AAI-DREG-RSP message having a message format with at least one paging offset field at block 310. For instance, IEEE 802.16p defines various types of MAC control messages, one of which is referred to as an AAI-DREG-RSP message. The AAI-DREG-RSP message is a MAC control message sent by the base station to the M2M device in a downlink (DL) channel in response to a deregistration request from the M2M device. The M2M device may send the deregistration request, for example, to enter an idle mode. The paging component 122-3 may send the M2M paging class parameter 132 to the M2M device in a known or new type field for the AAI-DREG-RSP.

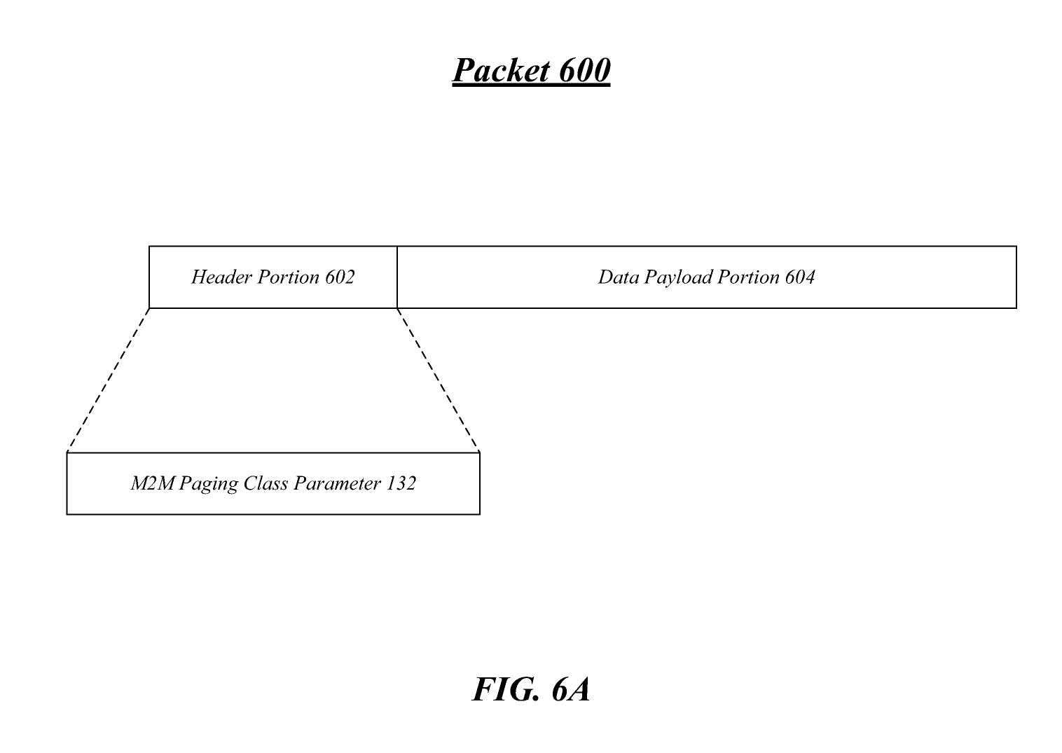

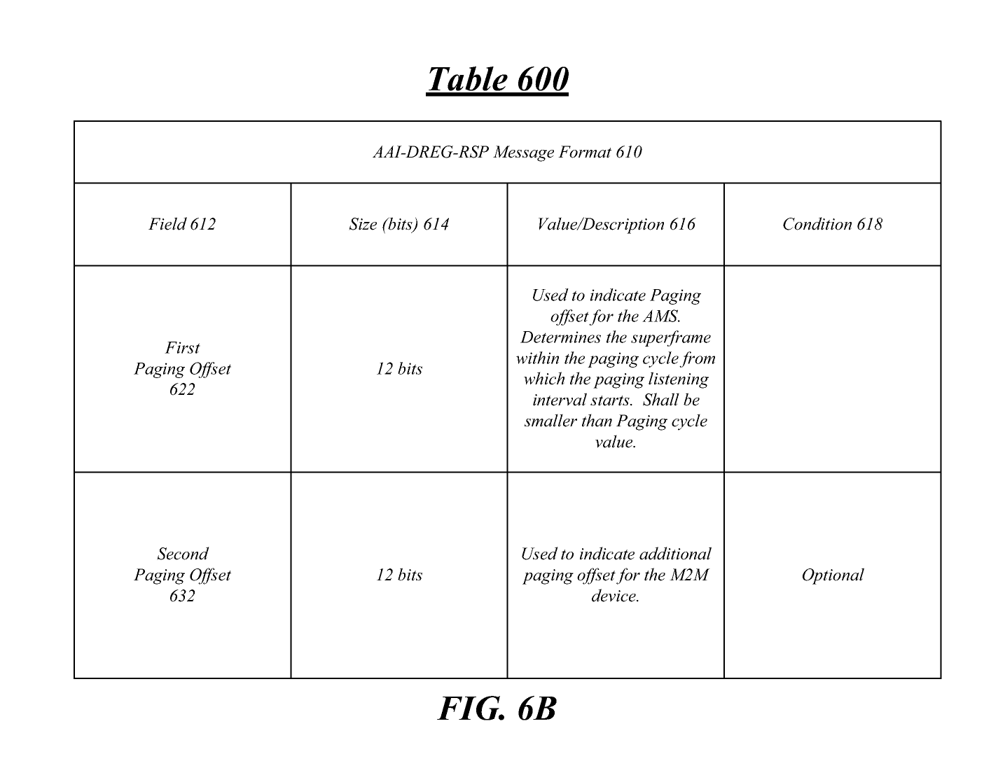

The logic flow 300 may send the M2M paging class parameter to the M2M device in an advanced air interface deregistration response (AAI-DREG-RSP) message, the AAI-DREG-RSP message having a message format with a first paging offset field and a second paging offset field at block 312. For instance, IEEE 802.16p explicitly defines two paging offset fields for an AAI-DREG-RSP message, as shown in table 600 of FIG. 6. The first paging offset field is used to indicate a paging offset value for the AMS. The first paging offset determines the superframe within the paging cycle 126-2 from which the paging listening interval (e.g., availability interval) starts. According to IEEE 802.16p, the first paging offset value shall be smaller than a paging cycle value. The second paging offset field is used to indicate additional paging offset for the M2M device.

The logic flow 300 may send the M2M paging class parameter to the M2M device in an advanced air interface deregistration response (AAI-DREG-RSP) message, the AAI-DREG-RSP message having a message format with a first paging offset field and a second paging offset field each having a size of twelve bits at block 314. As previously described, IEEE 802.16p defines two paging offset fields. According to IEEE 802.16p, the first paging offset field (or value) may comprise 12 bits, and the second paging offset field (or value) may also comprise 12 bits. It may be appreciated that the first and second paging offset fields may use a different number of bits to represent paging offset values (e.g., M2M paging class parameter 132) other than 12 bits. It may be further appreciated that the first and second paging offset fields may each use a different number of bits relative to each other. The embodiments are not limited in this context.

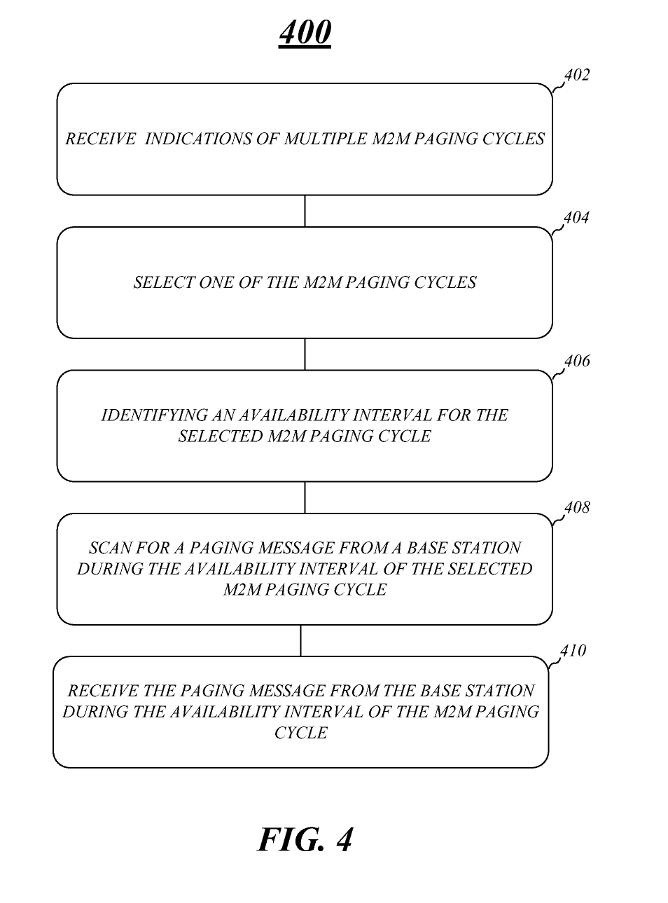

FIG. 4 illustrates an embodiment of a logic flow 400. The logic flow 400 may be representative of some or all of the operations executed by one or more embodiments described herein, such as the apparatus 100, for example. More particularly, the logic flow 400 may be performed by the apparatus 100 as implemented by user equipment for a broadband wireless access system, such as a M2M device.

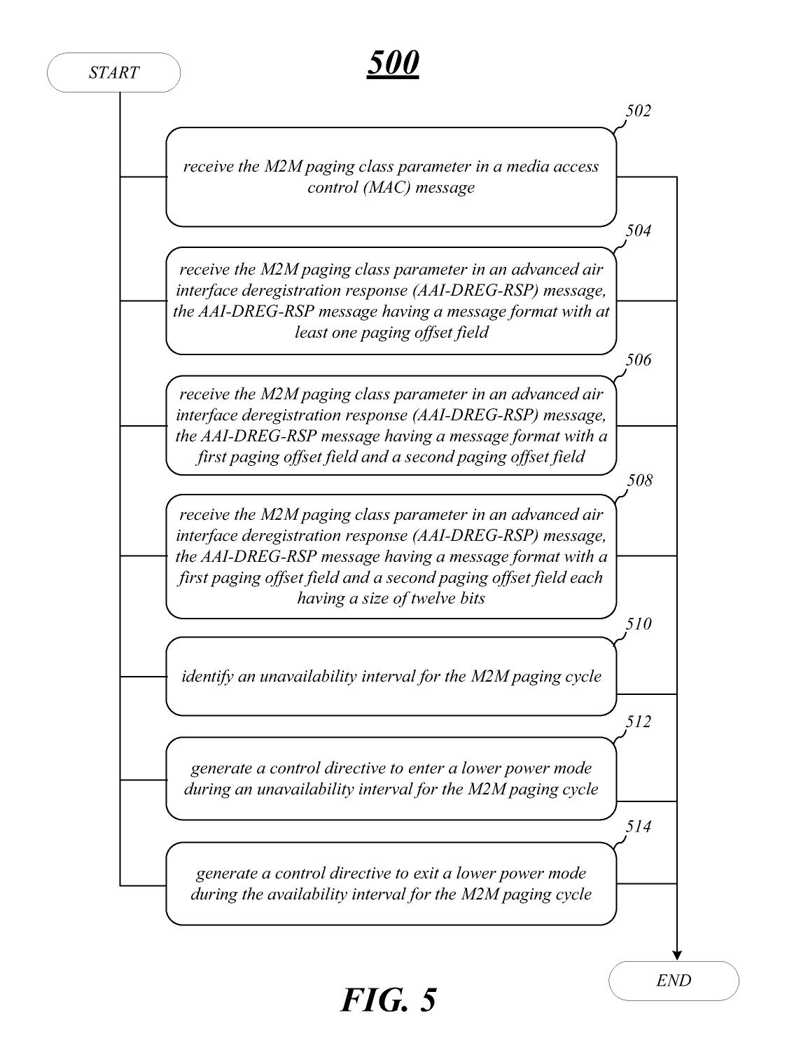

It is worthy to note that a M2M device implementing the apparatus 100 may perform same or different operations as those described with reference to FIGS. 2, 3. For instance, the M2M device implementing the apparatus 100 may implement client-side operations in response to server-side operations as described with reference to FIGS. 2, 3. Examples of client-side operations may include operations such as sending device information 104, receiving control messages 130, receiving paging messages 140, and other operations described with reference to FIGS. 4, 5.

It is also worthy to note that a M2M device may optionally include or omit the device identifier component 122-1 of the apparatus 100, depending on whether the device identifier component 122-1 is implemented by system equipment for a wireless network. In those cases where system equipment, such as a base station, implements the device identifier component 122-1, a M2M device may also include the device identifier component 122-1 to provide additional indicia of M2M features not readily accessible by the system equipment, such as connected devices, peripherals, power supplies, and so forth.

In the illustrated embodiment shown in FIG. 4, the logic flow 400 may receive indications of multiple M2M paging cycles at block 402. For instance, the paging component 122-3 of the apparatus 100 implemented by the M2M device may detect multiple paging cycles based on signals received from a base station or eNodeB, such as control signals or paging signals. In another example, the paging component 122-3 may detect multiple paging cycles based on a base station identifier. The paging component 122-3 may maintain a list of base station identifiers each associated with one or more defined paging cycles. The paging component 122-3 may use a base station identifier to retrieve the one or more defined paging cycles associated with the base station from the list of base station identifiers. Other indicators and detection mechanisms may be used, and the embodiments are not limited in this context.

The logic flow 400 may select one of the M2M paging cycles at block 404. For example, the paging component 122-3 may select one of the multiple M2M paging cycles from a list of defined paging cycles. The defined paging cycles may be derived from the list of base station identifiers as previously described. The defined paging cycles may also be a separate list of defined paging cycles. In one embodiment, the list of defined paging cycles may be prioritized by design parameters suitable for the M2M device. For instance, the list of defined paging cycles may be ordered based on a length for a paging cycle. The list of defined paging cycles may be ordered based on user preference, such as a developer, manufacturer or operator of the M2M device. The list of defined paging cycles may be ordered based on one or more M2M features of the M2M device. The list of defined paging cycles may be ordered based on power requirements of the M2M device. Other ordering techniques can be used suitable for a given implementation, and the embodiments are not limited in this context.

The logic flow 400 may identify an availability interval for the selected M2M paging cycle at block 406. For instance, the paging component 122-3 of the M2M device may receive the M2M paging class parameter 132 from a base station or eNodeB, and utilize one of the techniques previously described with reference to FIG. 3 to identify an availability interval of the M2M paging cycle 126-2.

The logic flow 400 may scan for a paging message from a base station during the availability interval of the selected M2M paging cycle at block 408. For instance, the paging component 122-3 of the M2M device may set paging operations for the M2M device based on the M2M paging cycle 126-2, and apply power to a RF interface to initiate scanning operations for paging messages 140 from a base station or eNodeB before or during the availability interval for the M2M paging cycle 126-2.

The logic flow 400 may receive the paging message from the base station during the availability interval of the selected M2M paging cycle at block 410. For instance, the paging component 122-3 of the M2M device may receive a paging message 140 from the base station or eNodeB during the availability interval of the M2M paging cycle 126-2 in order to communicate with a wireless network to send and/or receive data or management traffic

FIG. 5 illustrates an embodiment of a logic flow 500. The logic flow 500 may be representative of some or all of the operations executed by one or more embodiments described herein, such as the paging component 122-3 of the apparatus 100, for example. More particularly, the logic flow 500 may be implemented by the paging component 122-3 to receive a control message 130 with the M2M class parameter 132 by one or more M2M devices.

As previously described with reference to the logic flow 400, the M2M device may receive various indications of multiple paging cycles at block 404. In one embodiment, the paging component 122-3 may receive a M2M paging class parameter 132 at the M2M device from a base station or eNodeB, and select the M2M paging cycle based on the received paging class parameter. For instance, the paging component 122-3 of the apparatus 100 implemented by a M2M device may receive the M2M paging class parameter 132 from a base station or eNodeB, and utilize one of the techniques previously described with reference to FIG. 3 to identify the M2M paging cycle 126-2.

In the illustrated embodiment shown in FIG. 5, the logic flow 500 may receive the M2M paging class parameter in a media access control (MAC) message at block 502. For instance, the paging component 122-3 of the M2M device may receive the M2M paging class parameter 132 in a control message 130, with the control message 130 comprising a MAC control message as defined by any known communications protocols, standards or specifications, such as one or more of the IEEE 802.16 Standards or 3GPP LTE Specifications. For instance, the control message 130 may comprise a MAC control message for IEEE 802.16p, among others.

The logic flow 500 may receive the M2M paging class parameter in an advanced air interface deregistration response (AAI-DREG-RSP) message, the AAI-DREG-RSP message having a message format with at least one paging offset field at block 504. For instance, the paging component 122-3 of the M2M device may receive the M2M paging class parameter 132 an AAI-DREG-RSP message, and associated paging offset fields, as defined by IEEE 802.16p.

The logic flow 500 may receive the M2M paging class parameter in an advanced air interface deregistration response (AAI-DREG-RSP) message, the AAI-DREG-RSP message having a message format with a first paging offset field and a second paging offset field at block 506. For instance, the paging component 122-3 of the M2M device may receive the M2M paging class parameter 132 in a first paging offset field and/or a second paging offset field of an AAI-DREG-RSP message as defined by IEEE 802.16p.

The logic flow 500 may receive the M2M paging class parameter in an advanced air interface deregistration response (AAI-DREG-RSP) message, the AAI-DREG-RSP message having a message format with a first paging offset field and a second paging offset field each having a size of twelve bits at block 508. For instance, the paging component 122-3 of the M2M device may receive the M2M paging class parameter 132 as a 12 bit value in a first paging offset field and/or a second paging offset field of an AAI-DREG-RSP message as defined by IEEE 802.16p.

The logic flow 500 may identify an unavailability interval for the M2M paging cycle at block 510. For instance, the paging component 122-3 of the M2M device may receive the M2M paging class parameter 132 from a base station or eNodeB, and utilize one of the techniques previously described with reference to FIG. 3 to identify an unavailability interval of the M2M paging cycle 126-2.

The logic flow 500 may generate a control directive to enter a lower power mode during an unavailability interval for the M2M paging cycle at block 512. For instance, the paging component 122-3 may generate and send a control directive to a power controller of the M2M device to cause the M2M device to enter idle mode during the unavailability interval of the M2M paging cycle 126-2.

The logic flow 500 may generate a control directive to exit a lower power mode during the availability interval for the M2M paging cycle at block 514. For instance, the paging component 122-3 may generate and send a control directive to a power controller of the M2M device to cause the M2M device to exit idle mode during the availability interval of the M2M paging cycle 126-2.

FIG. 6A illustrates an embodiment of a packet 600. The packet 600 may illustrate a sample digital data transmission or packet data unit (PDU) suitable for a network to communicate control information for configuring a M2M device or a non-M2M device for different paging cycles. In one embodiment, the packet 600 may be a media access control (MAC) PDU constructed in accordance with one or more 3GPP LTE Specifications. In one embodiment, the packet 600 may be a MAC PDU constructed in accordance with one or more IEEE 802.16 Standards. Other packet or message formats may be used as well, and the embodiments are not limited to these examples.

In the illustrated embodiment shown in FIG. 6A, the packet 600 may comprise a header portion 602 and a data payload portion 604. The header portion 602 may comprise various type fields with encodings for a MAC signaling header type. One or more of the type fields may be for a paging class parameter 128-d, such as a M2M paging class parameter 132, among other types of control information for configuring a M2M device or a communications network for enhanced paging operations. The data payload portion 604 may comprise payload data for a M2M device.

FIG. 6B illustrates a table 600 illustrating an AAI-DREG-RSP message format 610 as defined by IEEE 802.16p suitable for transporting a M2M paging class parameter 132. As shown in table 600, the AAI-DREG-RSP message format 610 includes a first paging offset field 622 and a second paging offset field 632.

The first and second paging offset fields 622, 632, respectively, may individually or collectively carry one or more paging class parameters 128-d each representing a corresponding paging class 124-b. In one embodiment, the first paging offset field 622 may be for a value to indicate a first paging cycle, and the second paging offset field 632 may be for a value to indicate a second paging cycle. For example, the first paging offset field 622 may be for a paging class parameter 128-1 to indicate a paging cycle 126-1 for a non-M2M device, and the second paging offset field 632 may be for a M2M paging class parameter 128-2 (or M2M paging class parameter 132) to indicate a paging cycle 126-2 for a M2M device. In another example, the first paging offset field 622 may be for a paging class parameter 128-2 (or M2M paging class parameter 132) to indicate a paging cycle 126-2 for a M2M device, and the second paging offset field 632 may be for a non-M2M paging class parameter 128-1 to indicate a paging cycle 126-1 for a non-M2M device. In yet another example, the first and second paging offset fields 622, 632, respectively, may individually or collectively carry a paging class parameter 128-2 (or M2M paging class parameter 132) to indicate a paging cycle 126-2 for a M2M device. In still another example, the first and second paging offset fields 622, 632, respectively, may individually or collectively carry a non-M2M paging class parameter 128-1 to indicate a paging cycle 126-1 for a non-M2M device. The embodiments are not limited to these examples.

In one embodiment, the first and second paging offset fields 622, 632, respectively, have a same number of bits. For example, the first and second paging offset fields 622, 632 may each comprise twelve bits. In one embodiment, the first and second paging offset fields 622, 632, respectively, have a different number of bits. For example, the first paging offset field 622 may comprise twelve bits, and the second paging offset field 632 may comprise two bits. The first and second paging offset fields 622, 632 may have any number of bits as needed for a device, system or paging class parameter 128-d as desired for a given implementation, and the embodiments are not limited in this context.

In one embodiment, the first paging offset field 622 has a field size 614 of 12 bits. The first paging offset field 622 also has a value/description 616 describing that a first paging offset value in the first paging offset field 622 is used to indicate a paging offset for the AMS. The first paging offset value in the first paging offset field 622 is used to determine the superframe within a paging cycle 126-c from which the paging listening interval (e.g., availability interval) starts. According to IEEE 802.16p, the first paging offset value in the first paging offset field 622 shall be smaller than a paging cycle value.

In one embodiment, the second paging offset field 632 has a field size 614 of 12 bits. The second paging offset field 632 also has a value/description 616 describing that a second paging offset value in the second paging offset field 632 is used to indicate additional paging offset within a paging cycle 126-c for a M2M device. Further, the second paging offset field 632 has a condition 618 indicating that the second paging offset value is optional for a given AAI-DREG-RSP message.

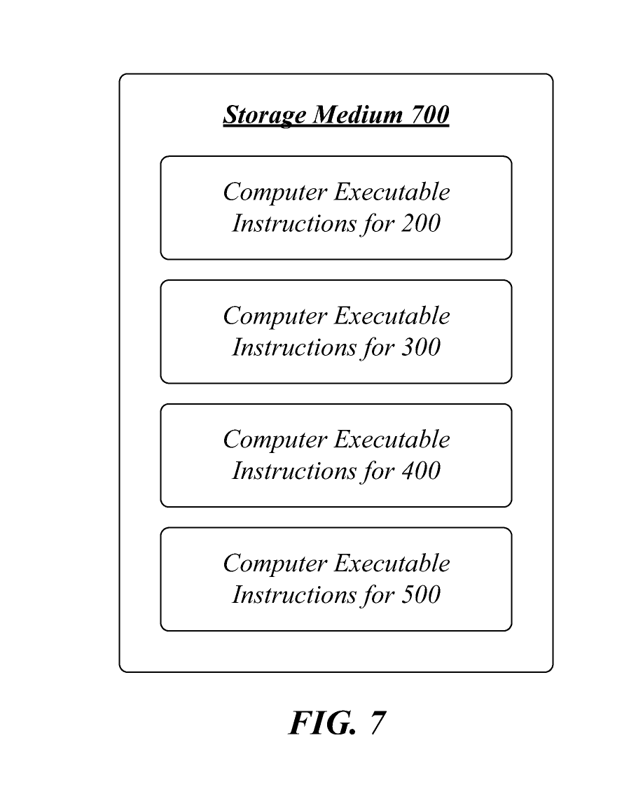

FIG. 7 illustrates an embodiment of a storage medium 700. The storage medium 700 may comprise an article of manufacture. In one embodiment, the storage medium 700 may comprise any non-transitory computer readable medium or machine readable medium, such as an optical, magnetic or semiconductor storage. The storage medium may store various types of computer executable instructions, such as instructions to implement one or more of the logic flows 200, 300, 400 and/or 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The embodiments are not limited in this context.

FIG. 8 illustrates an embodiment of a device 800 for use in a broadband wireless access network. Device 800 may implement, for example, apparatus 100, storage medium 700 and/or a logic circuit 830. The logic circuit 830 may include physical circuits to perform operations described for apparatus 100. As shown in FIG. 8, device 800 may include a radio interface 810, baseband circuitry 820, and computing platform 830, although embodiments are not limited to this configuration.

The device 800 may implement some or all of the structure and/or operations for the apparatus 100, storage medium 700 and/or logic circuit 830 in a single computing entity, such as entirely within a single device. Alternatively, the device 800 may distribute portions of the structure and/or operations for the apparatus 100, storage medium 700 and/or logic circuit 830 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 810 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. Radio interface 810 may include, for example, a receiver 812, a transmitter 816 and/or a frequency synthesizer 814. Radio interface 810 may include bias controls, a crystal oscillator and/or one or more antennas 818-f. In another embodiment, radio interface 810 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 820 may communicate with radio interface 810 to process receive and/or transmit signals and may include, for example, an analog-to-digital converter 822 for down converting received signals, a digital-to-analog converter 824 for up converting signals for transmission. Further, baseband circuitry 820 may include a baseband or physical layer (PHY) processing circuit 856 for PHY link layer processing of respective receive/transmit signals. Baseband circuitry 820 may include, for example, a processing circuit 828 for medium access control (MAC)/data link layer processing. Baseband circuitry 820 may include a memory controller 832 for communicating with processing circuit 828 and/or a computing platform 830, for example, via one or more interfaces 834.

In some embodiments, PHY processing circuit 826 may include a frame construction and/or detection module, in combination with additional circuitry such as a buffer memory, to construct and/or deconstruct communication frames, such as packet 600. Alternatively or in addition, MAC processing circuit 828 may share processing for certain of these functions or perform these processes independent of PHY processing circuit 826. In some embodiments, MAC and PHY processing may be integrated into a single circuit.

The computing platform 830 may provide computing functionality for the device 800. As shown, the computing platform 830 may include a processing component 840. In addition to, or alternatively of, the baseband circuitry 820, the device 800 may execute processing operations or logic for the apparatus 100, storage medium 700, and logic circuit 830 using the processing component 830. The processing component 830 (and/or PHY 826 and/or MAC 828) may comprise various hardware elements, software elements, or a combination of both. Examples of hardware elements may include devices, logic devices, components, processors, microprocessors, circuits, processor circuits (e.g., processor circuit 120), circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 830 may further include other platform components 850. Other platform components 850 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 800 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, node B, subscriber station, mobile subscriber center, radio network controller, router, hub, gateway, bridge, switch, machine, or combination thereof. Accordingly, functions and/or specific configurations of device 800 described herein, may be included or omitted in various embodiments of device 800, as suitably desired. In some embodiments, device 800 may be configured to be compatible with protocols and frequencies associated one or more of the 3GPP LTE Specifications and/or IEEE 802.16 Standards for WMANs, and/or other broadband wireless networks, cited herein, although the embodiments are not limited in this respect.

Embodiments of device 800 may be implemented using single input single output (SISO) architectures. However, certain implementations may include multiple antennas (e.g., antennas 818-f) for transmission and/or reception using adaptive antenna techniques for beamforming or spatial division multiple access (SDMA) and/or using MIMO communication techniques.

The components and features of device 800 may be implemented using any combination of discrete circuitry, application specific integrated circuits (ASICs), logic gates and/or single chip architectures. Further, the features of device 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

FIG. 9 illustrates an embodiment of a broadband wireless access system 900. As shown in FIG. 9, broadband wireless access system 900 may be an internet protocol (IP) type network comprising an internet 910 type network or the like that is capable of supporting mobile wireless access and/or fixed wireless access to internet 910. In one or more embodiments, broadband wireless access system 900 may comprise any type of orthogonal frequency division multiple access (OFDMA) based wireless network, such as a system compliant with one or more of the 3GPP LTE Specifications and/or IEEE 802.16 Standards, and the scope of the claimed subject matter is not limited in these respects.

In the exemplary broadband wireless access system 900, access service networks (ASN) 914, 918 are capable of coupling with base stations (BS) 914, 920 (or (or eNodeB), respectively, to provide wireless communication between one or more fixed devices 916 and internet 110, or one or more mobile devices 922 and Internet 110. One example of a M2M device 916 and a non-M2M device 922 is device 800, with the M2M device 916 comprising a M2M version of device 800 and the non-M2M device 922 comprising a non-M2M version of device 800. ASN 912 may implement profiles that are capable of defining the mapping of network functions to one or more physical entities on broadband wireless access system 900. Base stations 914, 920 (or eNodeB) may comprise radio equipment to provide RF communication with M2M device 916 and non-M2M device 922, such as described with reference to device 800, and may comprise, for example, the PHY and MAC layer equipment in compliance with a 3GPP LTE Specification or an IEEE 802.16 Standard. Base stations 914, 920 (or eNodeB) may further comprise an IP backplane to couple to Internet 910 via ASN 912, 918, respectively, although the scope of the claimed subject matter is not limited in these respects.

Broadband wireless access system 900 may further comprise a visited connectivity service network (CSN) 924 capable of providing one or more network functions including but not limited to proxy and/or relay type functions, for example authentication, authorization and accounting (AAA) functions, dynamic host configuration protocol (DHCP) functions, or domain name service controls or the like, domain gateways such as public switched telephone network (PSTN) gateways or voice over internet protocol (VoIP) gateways, and/or internet protocol (IP) type server functions, or the like. However, these are merely example of the types of functions that are capable of being provided by visited CSN 924 or home CSN 926, and the scope of the claimed subject matter is not limited in these respects. Visited CSN 124 may be referred to as a visited CSN in the case where visited CSN 924 is not part of the regular service provider of M2M device 916 or non-M2M device 922, for example where M2M device 916 or non-M2M device 922 is roaming away from their respective home CSN 926, or where broadband wireless access system 900 is part of the regular service provider of M2M device 916 or non-M2M device 922 but where broadband wireless access system 900 may be in another location or state that is not the main or home location of M2M device 916 or non-M2M device 922.

In one embodiment, M2M device 916 may be a fixed device located anywhere within range of one or both base stations 914, 920, such as in or near a home or business to provide home or business customer broadband access to Internet 910 via base stations 914, 920 and ASN 912, 918, respectively, and home CSN 926. It is worthy to note that although M2M device 916 is generally disposed in a stationary location, it may be moved to different locations as needed. Non-M2M device 922 may be utilized at one or more locations if the non-M2M device 922 is within range of one or both base stations 914, 920, for example.

In accordance with one or more embodiments, operation support system (OSS) 928 may be part of broadband wireless access system 900 to provide management functions for broadband wireless access system 900 and to provide interfaces between functional entities of broadband wireless access system 900. Broadband wireless access system 900 of FIG. 9 is merely one type of wireless network showing a certain number of the components of broadband wireless access system 900, and the scope of the claimed subject matter is not limited in these respects.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Furthermore, in the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements.

In addition, the term “and/or” may mean “and,” it may mean “or,” it may mean “exclusive-or,” it may mean “one,” it may mean “some, but not all,” it may mean “neither,” and/or it may mean “both,” although the scope of claimed subject matter is not limited in this respect. In the following description and/or claims, the terms “comprise” and “include,” along with their derivatives, may be used and are intended as synonyms for each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the scope of the appended claims.

1. A computer-implemented method, comprising:
establishing a wireless connection with a machine-to-machine (M2M) device;
selecting a paging class for the M2M device from among multiple paging classes, each paging class associated with a different paging cycle and paging class parameter, with at least one of the multiple paging classes comprising a M2M paging class associated with a M2M paging cycle and a M2M paging class parameter; and assigning the M2M device to the M2M paging class.

2. The computer-implemented method of claim 1, comprising sending the M2M paging class parameter to the M2M device, the M2M paging class parameter to indicate the M2M paging cycle.

3. The computer-implemented method of claim 1, comprising sending the M2M paging class parameter to the M2M device in a downlink (DL) control message, the M2M paging class parameter to indicate the M2M paging cycle.

4. The computer-implemented method of claim 1, comprising sending the M2M paging class parameter to the M2M device in a media access control (MAC) message.

5. The computer-implemented method of claim 1, comprising determining a device is the M2M device from device information received from the M2M device.

6. The computer-implemented method of claim 1, comprising sending a paging message to the M2M device in an interval of the M2M paging cycle.

7. At least one machine readable medium comprising a plurality of instructions that in response to being executed on a computing device cause the computing device to carry out a method according to claim 1.

8. An apparatus, comprising:
a processor circuit;
a connection manager component arranged for execution by the processor circuit to establish a wireless connection with a device; and
a paging component arranged for execution by the processor circuit to select a paging class for the device from among multiple paging classes, each paging class associated with a different paging cycle and paging class parameter, with at least one of the multiple paging classes comprising a M2M paging class associated with a M2M paging cycle and a M2M paging class parameter.

9. The apparatus of claim 8, the paging component arranged to receive a M2M indicator indicating the device is a M2M device, and assign the M2M device to the M2M paging class.

10. The apparatus of claim 8, the paging component arranged to send the M2M paging class parameter to the M2M device in a control message.

11. The apparatus of claim 8, the paging component arranged to broadcast the M2M paging class parameter to multiple M2M devices, including the M2M device, in a control channel.

12. The apparatus of claim 8, the paging component arranged to send a paging message to the M2M device in an interval of the M2M paging cycle.

13. The apparatus of claim 8, comprising a radio frequency (RF) transceiver coupled to the processor circuit, the RF transceiver arranged to transmit electromagnetic representations of a control message and a paging message.

14. An apparatus, comprising:
means to determine a device is a machine-to-machine (M2M) device;
means to select a paging class for the M2M device from among multiple paging classes, each paging class associated with a different paging cycle and paging class parameter, with at least one of the multiple paging classes comprising a M2M paging class associated with a M2M paging cycle and a M2M paging class parameter; and
means for assigning the M2M device to the M2M paging class.

15. The apparatus of claim 14, comprising means for sending the M2M paging class parameter to the M2M device in a control message.

16. The apparatus of claim 14, comprising means for broadcasting the M2M paging class parameter to the M2M device in a downlink (DL) control channel.

17. The apparatus of claim 14, comprising means for sending a paging message to the M2M device in an availability interval of the M2M paging cycle.

18. A computer-implemented method, comprising:
receiving indications of multiple M2M paging cycles;
selecting one of the M2M paging cycles;
identifying an availability interval for the selected M2M paging cycle; and
scanning for a paging message from a base station during the availability interval of the selected M2M paging cycle.

19. The computer-implemented method of claim 18, comprising detecting multiple paging cycles based on signals received over a downlink (DL) control channel.

20. The computer-implemented method of claim 18, comprising detecting multiple paging cycles based on an identifier.

21. The computer-implemented method of claim 18, comprising selecting one of the multiple M2M paging cycles from a list of defined paging cycles.

22. The computer-implemented method of claim 18, comprising:
receiving a M2M paging class parameter by the M2M device; and
selecting the M2M paging cycle based on the M2M paging class parameter.

23. The computer-implemented method of claim 18, comprising receiving the paging message during the availability interval of the M2M paging cycle.

24. The computer-implemented method of claim 18, comprising identifying an unavailability interval for the M2M paging cycle.

25. The computer-implemented method of claim 18, comprising generating a control directive to enter a lower power mode during an unavailability interval for the M2M paging cycle.

26. The computer-implemented method of claim 18, comprising generating a control directive to exit a lower power mode during the availability interval for the M2M paging cycle.

27. At least one machine readable medium comprising a plurality of instructions that in response to being executed on a computing device cause the computing device to carry out a method according to claim 18.

28. An apparatus, comprising:
a processor circuit;
a connection manager component arranged for execution by the processor circuit to establish a wireless connection with a base station; and
a paging component arranged for execution by the processor circuit to receive a M2M paging class parameter over the wireless connection, the M2M paging class parameter to indicate a M2M paging cycle.

29. The apparatus of claim 28, the paging component arranged to identify an availability interval for the M2M paging cycle, and scan for a paging message from the base station during the availability interval of the M2M paging cycle.

30. The apparatus of claim 28, the paging component arranged to receive the M2M paging class parameter in a control message.

31. The apparatus of claim 28, the paging component arranged to receive a paging message for the M2M device in an availability interval of the M2M paging cycle.

32. The apparatus of claim 28, comprising a radio frequency (RF) transceiver coupled to the processor circuit, the RF transceiver arranged to receive electromagnetic representations of a control message and a paging message.
